(19) United States
(12) Patent Application Publication
(10) Pub. No.: US 2005/0284399 A1
(43) Pub. Date: Dec. 29, 2005

(54) Animal enclosure with cover

(76) Inventor: Margaret L. Asma, Mesa, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/154,868

(22) Filed: Jun. 15, 2005

Related U.S. Application Data
(60) Provisional application No. 60/583,838, filed on Jun. 29, 2004.

(51) Int. Cl. A01K 1/03; A01K 31/06

(52) U.S. Cl. 119/452

(57) ABSTRACT

An animal enclosure has an upper end and an opposing lower end. A waste collection tray underlies the lower end of the animal enclosure. A cover is attached to the waste collection tray, and is movable between a stored position relative to the waste collection tray and a deployed position relative to the waste collection tray substantially enclosing the animal enclosure.

### CROSS REFERENCE TO RELATED APPLICATIONS

This application claims the benefit of U.S. Provisional Application Ser. No. 60/583,838, filed 29 Jun. 2004.

### FIELD OF THE INVENTION

The present invention relates to animal enclosures and to covers for animal enclosures.

### BACKGROUND OF THE INVENTION

There is a long history of birds and other animals being kept in captivity. They are kept in cages or enclosures for breeding, for sale, for maintaining as ornamental or decorative additions or simply as pets and companions. Each different use has different requirements for maintenance, but each requires that the animals be fed and maintained in a healthy state.

Two essential ingredients for maintaining a caged animal in a healthy and happy state are providing ongoing cleanliness of the cage and providing the caged animal with a sense of security and privacy. Maintaining a clean cage normal begins and ends with providing a way to collect waste generated by the animal and also unused and uneaten food scattered throughout the cage by the animal. While these goals are easily identified, they are not easily and inexpensively solved. For instance, the prior art provides highly specialized cages having features uniquely adapted to collect waste from the cage. Furthermore, many skilled artisans have devoted considerable effort and resources toward the development of specialized feeders for collecting recapturing displaced and unused food so that it may be reused and for reducing displaced food from being wasted. In both instance the results have not been entirely acceptable as current devices and improvements in the art are expensive and not easily built and are difficult to use.

Maintaining in a caged animal a sense of security and privacy is also not easily solved. Current efforts to provide a caged animal with a sense of security and privacy normally involve simply periodically placing a towel or sheet or other covering over the cage to darken the interior space and to limit the animal's view to the interior of the cage. However, towels and sheets and other coverings often inadvertently fall away from the cage and are cumbersome to properly and easily install, and must usually be cleaned before being placed back into storage.

Given these and other deficiencies in the art, the need for certain new and useful improvements is evident.

### SUMMARY OF THE INVENTION

According to the invention, an animal enclosure assembly includes an animal enclosure, and a cover attached to a base positioned adjacent the animal enclosure, in which the cover is movable between a stored position relative to the base and a deployed position relative to the base substantially enclosing the animal enclosure. The base has a pocket, and the cover is disposed within the pocket in its stored position and projects outwardly from the pocket in its deployed position. The animal enclosure has an upper end and an opposing lower end, and the base underlies the lower end of the animal enclosure. The base consists of a continuous sidewall having an open top and a closed bottom, and the lower end of the animal enclosure projecting through the open top and is positioned against the closed bottom. The base is preferably coupled to the enclosure, and the cover is preferably fashioned with a drawstring or the like for constrictively closing the cover about the animal enclosure in the deployed position of the cover.

According to the invention, an animal enclosure assembly includes an animal enclosure, a base, supporting a pocket, coupled to the animal enclosure, and a cover attached to the base and movable between a stored position within the pocket and a deployed position projecting outwardly from the pocket substantially enclosing the animal enclosure. The animal enclosure has opposing first and second ends, and the base is positioned against the first end. The base includes a continuous sidewall having an open top and a closed bottom, in which the first end of the animal enclosure projects through the open top and is positioned against the closed bottom. Preferably, the pocket is carried by the continuous sidewall and the cover is attached to the continuous sidewall. The cover is preferably fashioned with a drawstring or the like for constrictively closing the cover about the animal enclosure in the deployed position of the cover.

According to the invention, an animal enclosure assembly includes an animal enclosure having an upper end and an opposing lower end, a waste collection tray underlying the lower end of the animal enclosure, and a cover attached to the waste collection tray and movable between a stored position relative to the waste collection tray and a deployed position relative to the waste collection tray substantially enclosing the animal enclosure. The waste collection tray includes a continuous sidewall having an open top and a closed bottom, and the lower end of the animal enclosure projects through the open top and is positioned against the closed bottom. The waste collection tray has a pocket, and the cover is disposed within the pocket in its stored position and projects outwardly from the pocket in its deployed position. Preferably, the pocket is carried by the continuous sidewall, and the cover is attached to the continuous sidewall. The cover is preferably fashioned with a drawstring or the like for constrictively closing the cover about the animal enclosure in the deployed position of the cover.

Consistent with the foregoing summary of preferred embodiments, and the ensuing detailed description, which are to be taken together, the invention also contemplates associated apparatus and method embodiments.

### BRIEF DESCRIPTION OF THE DRAWINGS

Referring to the drawings:

FIG. 1 is a perspective view of an animal enclosure assembly including an animal enclosure and a base attached thereto incorporating a cover, portions of which are broken away for illustrative purposes;

FIG. 2 is a partially schematic side elevational view of the animal enclosure assembly of FIG. 1 in which the cover is concealed from view in a stored position relative to the base;

FIG. 3 is a view very similar to the view of FIG. 2 with the cover shown as it would appear deployed partially enclosing the animal enclosure;

FIG. 4 is a view very similar to the view of FIG. 3 with the cover shown as it would appear deployed totally enclosing the animal enclosure;

FIG. 5 is a sectional view taken along line 5-5 of FIG. 1;

FIG. 6 is a perspective view of the base of FIG. 1 shown with the cover disposed in its deployed position;

FIG. 7 is a view very similar to the view of FIG. 6 with the cover shown disposed in its stored position;

FIG. 8 is an enlarged sectional view taken along line 8-8 of FIG. 7; and

FIG. 9 is a perspective view of a waste collection tray constructed and arranged in accordance with the principle of the invention.

### DETAILED DESCRIPTION OF PREFERRED EMBODIMENTS

Briefly, disclosed herein is an animal enclosure assembly, which includes an animal enclosure, and a base supporting a pocket. The base is positioned adjacent the animal enclosure being operative in conjunction therewith. According to the principle of the invention, a cover is attached to the base and is movable between a stored position within the pocket and a deployed position projecting outwardly from the pocket being available to substantially enclose the animal enclosure. The animal enclosure has opposing upper and lower ends, and in a particular embodiment the base is positioned against the lower end. The base includes a continuous sidewall having an open top and a closed bottom, in which the lower end of the animal enclosure projects through the open top and is positioned against the closed bottom. Preferably, the pocket is carried by the continuous sidewall and the cover is attached to the continuous sidewall. The cover is preferably fashioned with a drawstring or the like for constrictively closing the cover about the animal enclosure in the deployed position of the cover.

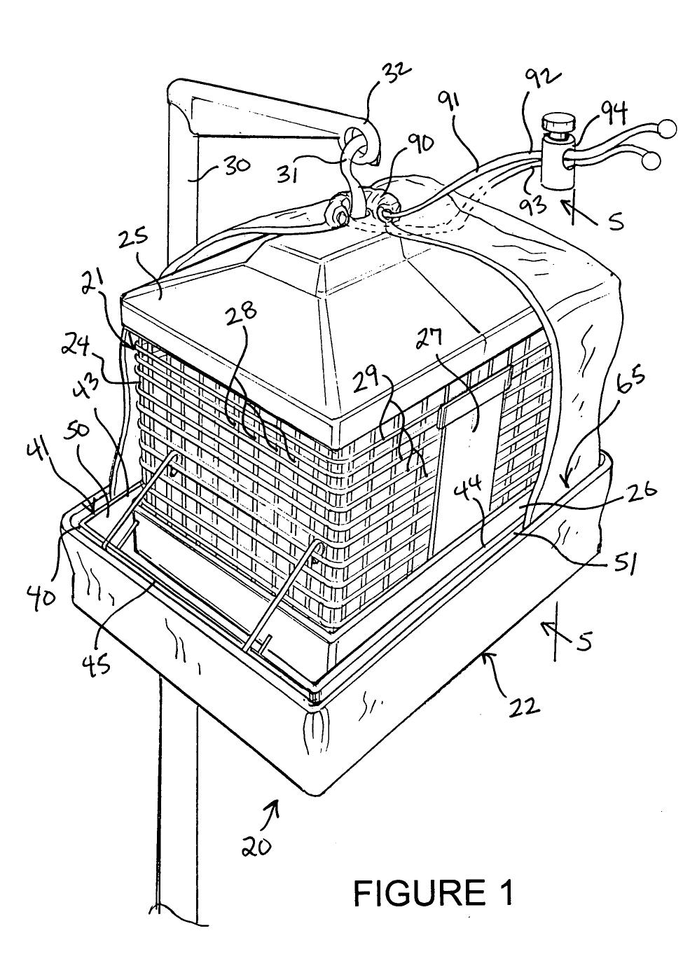

Turning now to the drawings, in which like reference characters indicate corresponding elements throughout the several views, attention is first directed to FIG. 1 in which there is seen a perspective view of an animal enclosure assembly 20 including an animal cage or enclosure 21 and a base 22 incorporating a cover 23, in accordance with the principle of the invention. In FIG. 1, portions of cover 23 are broken away for illustrative purposes showings its interrelationship with enclosure 21. Base 22 is positioned adjacent enclosure 22 as see in FIG. 1, in which cover 23, which is attached to base 22, is movable between a stored position relative to base 22 and a deployed position relative to base 22 as shown substantially enclosing enclosure 21.

Enclosure 21 a type for encaging an animal, and consists of a continuous sidewall 24 having an attached top 25 and bottom 26, in which continuous sidewall 24 and top 25 and bottom 26 separate an inside, in which birds or other animals are kept, from an outside. In accordance with conventional practice, continuous sidewall 24 incorporates a door 27, which can be opened for accessing the inside of enclosure 21 and closed for closing the inside of enclosure 21. In this instance, continuous sidewall 24 is constructed of a mesh of metal strands, including generally vertical strands 28 and generally horizontal strands 29, and top and bottom 25 and 26 are each constructed of plastic. It will be readily understood that enclosure 21 can be substantially any cage or enclosure separating an inside from an outside.

In this embodiment, enclosure 21 is suspended at an elevated location from a stand 30, only a portion of which is shown. In particular, this particular enclosure 21 incorporates an attached hook 31 attached to and projecting upwardly from top 25 and which engages an attachment end 32 of stand 30 being suspended therefrom. It will be readily apparent to one skilled in the art that substantially any device, structure, stand or the like may be used for suspending enclosure 21 at an elevated location. For the purpose of orientation and reference, it is to be understood that top 25 of enclosure 21 is the upper end of enclosure 21, that bottom 26 is the lower end of enclosure 21, and that base 22 is disposed underneath bottom 26 underlying enclosure 21.

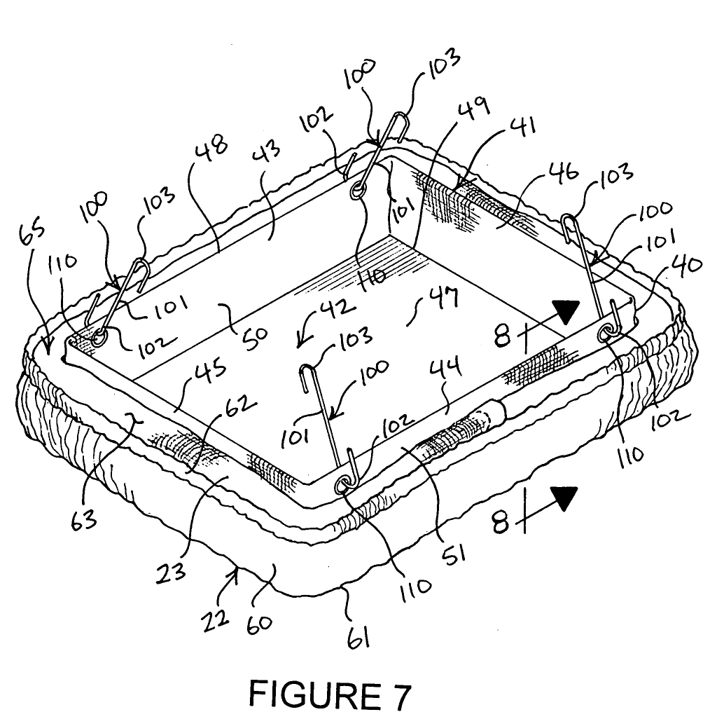

Referring now to FIG. 7, base 22 is the support structure for cover 23, and consists of a continuous sidewall 40 having an open top 41 and an opposing closed bottom 42. Continuous sidewall 40 includes opposed upstanding sidewalls 43 and 44, and opposed upstanding endwalls 45 and 46. A generally planar bottom wall 57 characterizes closed bottom 42. Sidewalls 43 and 44 and endwalls 44 and 45 project upwardly from bottom wall 47, and bottom wall 47 is generally horizontal relative to sidewalls 43 and 44 and endwalls 44 and 45. As a matter of reference, continuous sidewall 40 has a continuous upper edge 48 and an opposing continuous lower edge 49 disposed at bottom wall 47, an inner surface 50 and an opposing outer surface 51. Base 22 is overall generally rectangular in shape in the preferred embodiment set forth herein. Consistent with the teachings provided by this disclosure, it will be readily understood by those having regard for the relevant art that that base 22 can be configured in other shapes, such as square, triangular, round, etc.

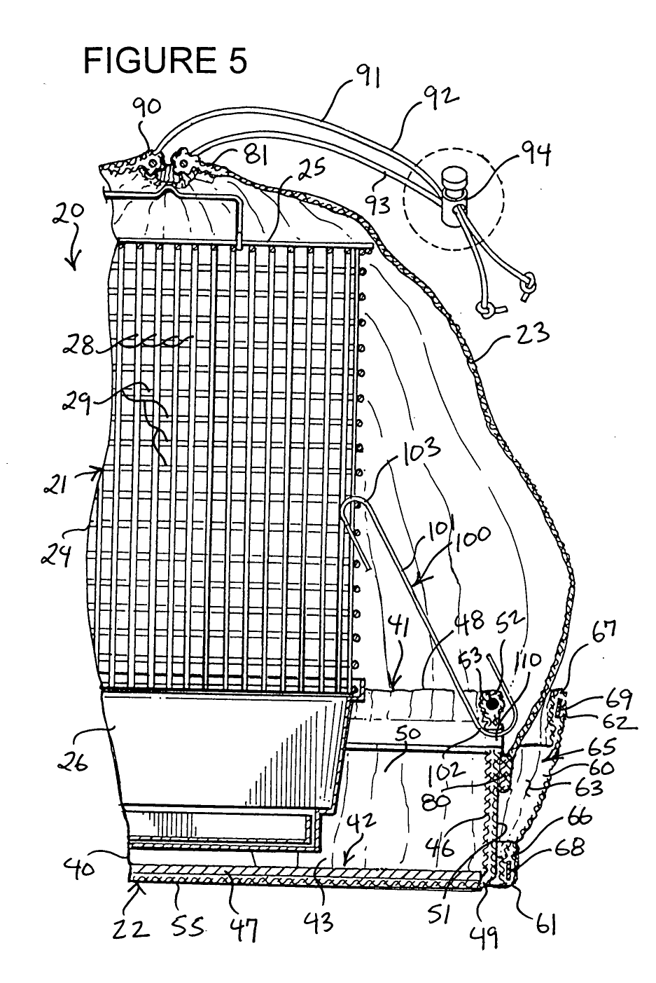

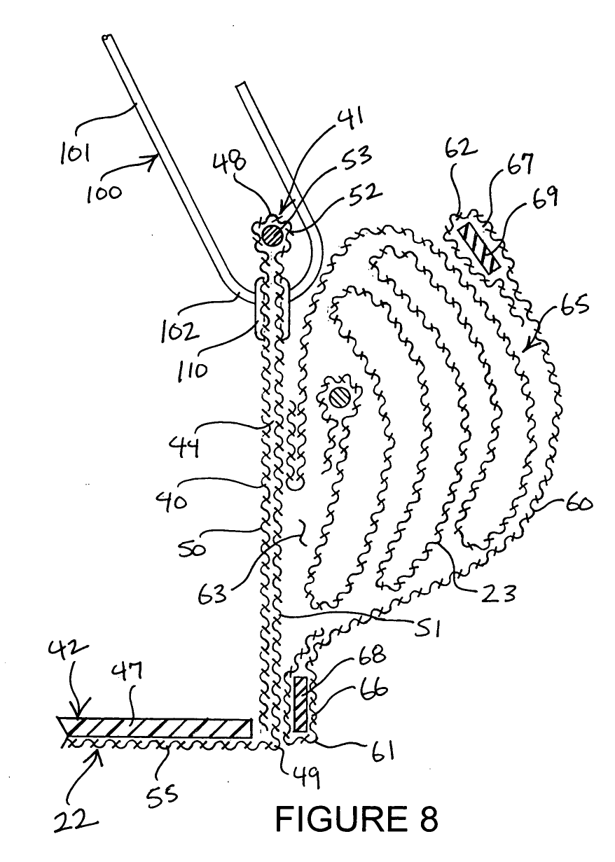

Bottom wall 47 is generally flat and rectangular and is preferably fashioned of plastic, wood, steel, aluminum, or other selected substantially rigid material or combination of materials providing a rigid and stable support of base 22. Here, sidewalls 43 and 44 and endwalls 45 and 46 are fashioned of a substantially pliant material, such as a woven or unwoven cloth material constructed of cotton, nylon, polyester, polypropylene, a blend of two or more of the foregoing, or other similar material or combination of materials being flexible and easily manipulated or influenced. In a particular manner of construction, and with momentary attention directed to FIGS. 5 and 8, bottom wall 47 is positioned atop a pliant base sheet 55, and preferably affixed thereto such as by a suitable adhesive, rivets, heat bonding, etc. Extremities of sheet 50 projecting outboard of the perimeter of bottom wall 47 are folded upwardly and their opposed, respectively ends secured to one another, such as by sewing, gluing, heat bonding, etc., thus forming continuous sidewall 40.

Continuous sidewall 40 can be fashioned with structural reinforcements for introducing structural rigidity into continuous sidewall 40, if desired. As a matter of example of this as seen in FIGS. 5 and 8, upper edge 48 of continuous sidewall 40 is fashioned with a hem 52 into which is positioned an elongate substantially rigid gusset 52, which is fashioned of heavy gauge wire, metal, plastic, wood, or the like. Preferably, gusset 52 extends along the entire perimeter of upper edge 48 thereby providing structural reinforcement to the entire extent of upper edge 48. Continuous sidewall 40 can be fashioned with additional attached gussets or the like for providing the desired measure of structural reinforcement.

Although continuous sidewall 40 is substantially pliant in the preferred embodiment herein disclosed, it is to be understood that it can be made of a substantially rigid material or combination of materials much like that of bottom 47. Furthermore, consistent with the teachings provided herein, it is to be understood that base 22, including continuous sidewall 40 and bottom wall 47, may be fashioned entirely of a substantially rigid material or combination of materials, if desired, and can be integrally formed, such as by molding or machining, or fashioned as a plurality of parts rigidly attached together by way of welding, mechanical fasteners, by joining the various parts together with suitable joint structure, etc.

Referring to FIGS. 5 and 8, base 22 additionally includes a continuous secondary sidewall 60, which confronts and is disposed along side outer surface 51 of continuous sidewall 40, in accordance with the principle of the invention. Continuous secondary sidewall 60 encircles continuous sidewall 40 and has a continuous lower edge 61 affixed to outer surface 51 of continuous sidewall 40 at lower edge 49, and an opposing continuous upper edge 62 opposing upper edge 48. Continuous lower edge 61 is affixed to outer surface 51 of continuous sidewall 40 at lower edge 49 with sewing, glue, rivets, heat bonding, staples, or the like. A storage space 63 is formed between outer surface 51 of continuous sidewall 40 and continuous secondary sidewall 60, in which the combination of outer surface 51 of continuous sidewall 40 and continuous secondary sidewall 60 forming storage space 63 therebetween produce a structure which is exemplary of a pocket denoted generally at 65. Because continuous secondary sidewall 60 encircles continuous sidewall 40, pocket 65 is a continuous or parametric pocket/receptacle, much like a moat encircling a castle, which is substantially coextensive relative to continuous sidewall 40, and this aspect is clearly shown in FIGS. 7.

Continuous secondary sidewall 60 is, like sidewalls 43 and 44 and endwalls 45 and 46, pliant and constructed of a pliant material, such as a woven or unwoven cloth material constructed of cotton, nylon, polyester, polypropylene, a blend of two or more of the foregoing, or other similar material or combination of materials being flexible and easily manipulated or influenced, in accordance with the principle of the invention. Preferably, pocket 65 incorporates features making it elastically constrictive. To provide this elastic constrictiveness in accordance with a preferred embodiment provided herein, lower and upper edges 61 and 62 are preferably fashioned with hems 66 and 67 into which elastic bands 68 and 69 are positioned elastically constricting lower and upper edges 61 and 62, respectively. If desired, only upper edge 62 may be fashioned to be elastically constrictive. Furthermore, the elastic constrictive character of pocket 65 may be provided by fashioning continuous sidewall 60 entirely or partially of an elastic material or combination of elastic materials.

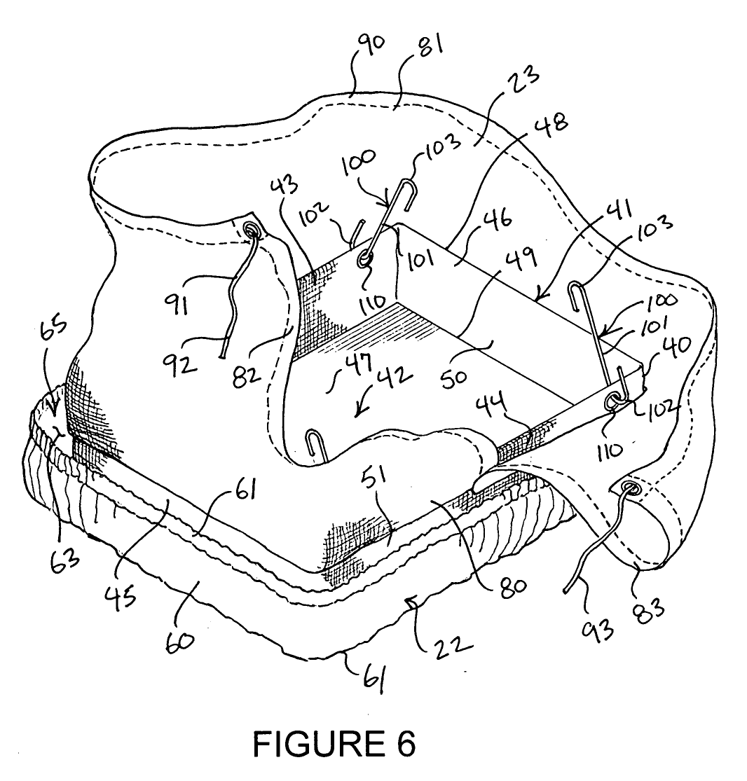

Regarding FIGS. 5 and 8 and also FIG. 6, cover 23 is a large, wide, and elongate sheet or sheet-like component that like continuous secondary sidewall 60 and sidewalls 43 and 44 and endwalls 45 and 46 is pliant and constructed of a pliant material, such as a woven or unwoven cloth material constructed of cotton, nylon, polyester, polypropylene, a blend of two or more of the foregoing, or other similar material or combination of materials being flexible and easily manipulated or influenced, in accordance with the principle of the invention. Cover 23 has an inner edge 80 and an opposing outer edge 81, and also opposing ends 82 and 83. Cover 23 encircles continuous sidewall 40, as does its inner edge 80, which is affixed to outer surface 51 of continuous sidewall 40 along the entire perimeter of continuous sidewall 40 in which ends 82 and 83 meet and overlap and are joined together at outer surface 51 of continuous sidewall 40. Inner edge 80 of cover 23 is affixed to outer surface 51 of continuous sidewall 40 with sewing, glue, rivets, etc., and the attachment point of inner edge 80 to outer surface 51 of continuous sidewall 40 is at a generally intermediate point between upper and lower edges 48 and 49 of continuous sidewall 40 at storage space 63 of pocket 65.

According to the principle of the invention, cover 23 is movable between a stored position within storage space 63 of pocket as shown in FIGS. 6 and 8, and a deployed position projecting outwardly from storage space 63 of pocket 65 as shown in FIG. 6. To position cover 23 into its stored position, cover 23 is simply taken up by hand and forcibly folded and compacted into storage space 63. The elastically constrictive characteristic of pocket 65 constricts and captures continuous secondary sidewall 60 at storage space 63 between continuous secondary sidewall 60 and outer surface 51 of continuous sidewall 40 retaining cover 23 in place being exemplary of a stored position of cover 23. To deploy cover 23 and thus place it in its deployed position, cover 23 is simply taken up by hand and pulled upwardly and outwardly from storage space 63 as shown in FIG. 6.

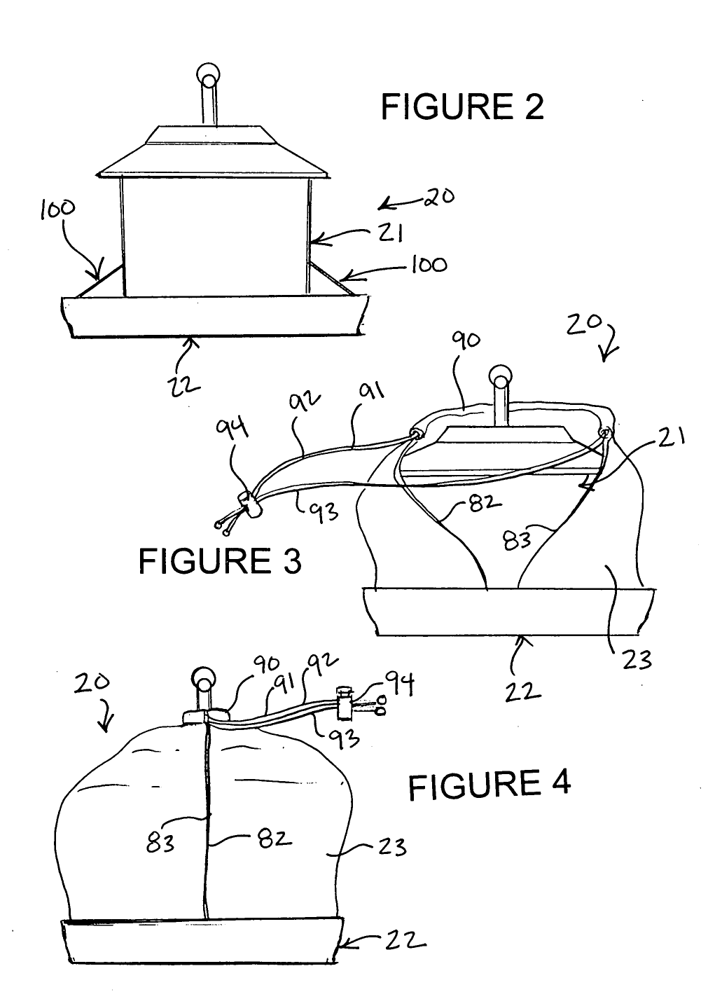

To employ base 22 and its attached cover 23 with enclosure 21 forming assembly 20 in accordance with a preferred embodiment as shown in FIG. 1, base 22 is positioned adjacent enclosure, in which the lower end of enclosure 21 is passed into and through open top 41 of base 22 and is positioned against closed bottom 42, in which continuous sidewall 40 encircles the lower end of enclosure 21 as substantially shown. Preferably, base 22 is then coupled to enclosure 21 so as to be suspended therefrom and securing it in place underlying the lower end of enclosure 21. Because base 22 is positioned beneath enclosure 21 as shown in FIG. 2, it functions quite well as a waste collection tray collecting feces, wasted food, and other waste material generated by an animal encaged in enclosure 21 and falling away from enclosure 21, in accordance with the principle of the invention. With cover 23 maintained in pocket 65, cover 23 is conveniently stored. To use cover 23, it may simply be taken up by hand and forcibly pulled upwardly and away from pocket 65 into its deployed position as shown in FIG. 3 and then wrapped around enclosure 21 as shown in FIG. 4 enclosing enclosure 21. Enclosing enclosure 21 with cover 23 provides a calming effect to caged animals, such domesticated birds or domesticated rodents or the like, encaged in enclosure 21 thus promoting rest and security. It is to be understood that cover 23 is sufficiently sized so that it may be taken up in its deployed position and used to enclose enclosure 21 by wrapping it about enclosure 21. To move cover 23 back into its stored position from its deployed position, one need only reverse the foregoing operation by removing or unwrapping cover 23 from enclosure 21 and forcibly inserting it back into pocket 65 for storage until later use.

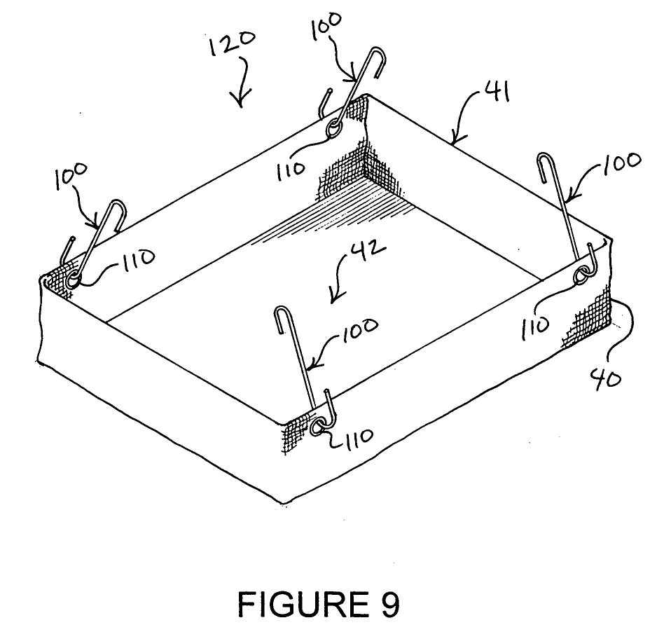

Preferably, cover 23 incorporates structure that allows it to be constrictively closed about enclosure 21. To accomplish this in accordance with a preferred embodiment and with reference to FIGS. 1, 4, 5, and 6, outer edge 81 of cover 23 is fashioned with a hem 90 through which a drawstring 91 extends having opposing free ends 92 and 93 projecting outwardly from hem 90 at ends 82 and 83 of cover 23. With additional reference to FIG. 9, free ends 92 and 93 of drawstring 91 pass through a spring clip 94. Drawstring 91 is used to constrict outer edge 81 as seen in FIGS. 1 and 4 to enclose enclosure 23 with cover 23, and spring clip 94 can be slid relative to free ends 92 and 93 to secure drawstring 91 in its constricted state closing outer edge 81 about enclosure 21 and to release drawstring 91 from its constricted state opening/enlarging outer edge 81. Any suitable drawstring form can be used for allowing the selective closing/constriction and opening of outer edge 81. Rather than using a drawstring as the mechanism for constricting outer edge 81 as herein described, this function can be accomplished with an elastic band, clips, by gathering outer edge 81 and bounding it together and tying it in place with a string or twine, etc. Drawstring 91 can be elastic if desired, or otherwise incorporate elastic features, for enhancing its constricting function.

Cover 23 can be secured about enclosure 21 in other ways. For instance, ends 82 and 83 of cover can be fashioned with mutual complementing fasteners that may used to detachably secure ends 82 and 83 together after cover 23 is wrapped about enclosure 21. Suitable fasteners that can be used for this purpose include, for instance, mutual snap fasteners, a hook and loop engagement structure, a zipper assembly, buttons and complementing button holes, etc.

Base 22 is preferably coupled to enclosure 21 with hangers 100. Looking to FIG. 5, each hanger 100 consists of an elongate element 101 fashioned of rigid metal or plastic or other substantially rigid material or combination of materials and having a lower end 102 formed in the shape of a hook engaging a grommet 110 carried by sidewall 40 and an opposing upper end 103 formed in the shape of a hook hookingly engaging one of the horizontal strands 29 of enclosure 21. In a preferred embodiment, four such hangers 100 are used to secure base 22 to enclosure, and less or more may be used depending on specific needs, specifications, or wishes. In FIG. 1, two hangers 100 are depicted at one end of enclosure 21 coupling endwall 45 of base 22 to enclosure 21, in which two opposing hangers are similarly used on the opposing end of enclosure 21 coupling endwall 46 to enclosure 21 but are concealed from view by cover 23. Not only may any desired number of hangers 100 be used to couple base 22 to enclosure 21, but also they may attached to base 22 at different locations for allowing them to function to attach base 22 to enclosure. As a matter of example of showing different attachment points of hangers 100 to base 22, FIGS. 6 and 7 shown hangers 100 attached to sidewalls 43 and 44.

Hangers 100 are attached to base 22 with grommets 110 attached to continuous sidewall 40, in which each hanger 100 has a hooked end that engages one of the grommets. This engagement arrangement is generally representative of a male and female engagement pair, in which the hook is the male element and the grommet is the complementing female element. It is to be understood that the positioning of these elements can be reversed, if desired, in which hanger 100 may be provided with a female engagement and base 22 may be provided with a complementing male engagement element.

Hangers 100 and grommets 110 are preferred for providing an easy, efficient, and inexpensive way to coupled base 22 to enclosure. Although it hardly seems worth mentioning, those having ordinary skill and regard for the relevant art will readily appreciate that other ways of coupling base 22 to enclosure 21 may be used without departing from the invention. For instance, rather than hooks base 22 may be fastened to enclosure 21 with ties, with mechanical fasteners such as screws or nut and bolt assemblies, or by way of any other suitable device or arrangement of devices capable of coupling/attaching base 22 to enclosure as herein described.

Although it is preferred that base 22 be coupled to enclosure 21, base 22 may simply be positioned adjacent enclosure 21 so that it may operate in conjunction with enclosure 21 as herein described. For instance, base 22 can, if desired, be supported by an auxiliary support structure, such as a stand or base, such that base 22 is positioned adjacent enclosure 21 allowing it to function in conjunction with enclosure 21 as set forth in this disclosure.

The invention has been described above with reference to a preferred embodiment. However, those skilled in the art will recognize that changes and modifications may be made to the embodiment without departing from the nature and scope of the invention. For instance, in FIG. 9 there is seen a waste collection tray 120 that in common with base 22 previously discussed shares continuous sidewall 40 including open top 41 and closed bottom 42, and also hooks 100 and grommets 110. The embodiment designated at 120 in FIG. 8 is fastened to or otherwise associated with an animal enclosure in the same manner as base 22 and is, like base 22, is to be placed beneath an animal enclosure to function as a waste collection tray collecting feces, wasted food, and other waste material generated by an animal encaged in the enclosure to which it is attached. The purpose of the embodiment set forth in FIG. 1 is to show the provision of a waste collection tray for use with an animal enclosure having no attached cover.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Apparatus, comprising:
an animal enclosure; and
a cover attached to a base positioned adjacent the animal enclosure;
the cover movable between a stored position relative to the base and a deployed position relative to the base substantially enclosing the animal enclosure.

2. Apparatus according to claim 1, further comprising:
the base having a pocket; and
the cover disposed within the pocket in its stored position and projecting outwardly from the pocket in its deployed position.

3. Apparatus according to claim 1, further comprising:
the animal enclosure having an upper end and an opposing lower end; and
the base underlying the lower end of the animal enclosure.

4. Apparatus according to claim 3, further comprising:
the base comprising a continuous sidewall having an open top and a closed bottom; and
the lower end of the animal enclosure projecting through the open top and positioned against the closed bottom.

5. Apparatus according to claim 4, further comprising the base coupled to the animal enclosure.

6. Apparatus according to claim 1, further comprising means for constrictively closing the cover about the animal enclosure in the deployed position of the cover.

7. Apparatus according to claim 6, wherein the means for constrictively closing the cover about the animal enclosure in the deployed position of the cover comprises a drawstring.

8. Apparatus, comprising:
an animal enclosure;
a base, supporting a pocket, coupled to the animal enclosure;
a cover attached to the base and movable between a stored position within the pocket and a deployed position projecting outwardly from the pocket substantially enclosing the animal enclosure.

9. Apparatus according to claim 8, further comprising:
the animal enclosure having opposing first and second ends; and
the base positioned against the first end.

10. Apparatus according to claim 9, further comprising:
the base comprising a continuous sidewall having an open top and a closed bottom; and
the first end of the animal enclosure projecting through the open top and positioned against the closed bottom.

11. Apparatus according to claim 10, wherein the pocket is carried by the continuous sidewall and the cover is attached to the continuous sidewall.

12. Apparatus according to claim 8, further comprising means for constrictively closing the cover about the animal enclosure in the deployed position of the cover.

13. Apparatus according to claim 12, wherein the means for constrictively closing the cover about the animal enclosure in the deployed position of the cover comprises a drawstring.

14. Apparatus, comprising:
an animal enclosure having an upper end and an opposing lower end;
a waste collection tray underlying the lower end of the animal enclosure; and
a cover attached to the waste collection tray and movable between a stored position relative to the waste collection tray and a deployed position relative to the waste collection tray substantially enclosing the animal enclosure.

15. Apparatus according to claim 14, further comprising:
the waste collection tray comprising a continuous sidewall having an open top and a closed bottom; and
the lower end of the animal enclosure projecting through the open top and positioned against the closed bottom.

16. Apparatus according to claim 15, further comprising:
the waste collection tray having a pocket; and
the cover disposed within the pocket in its stored position and projecting outwardly from the pocket in its deployed position.

17. Apparatus according to claim 16, wherein the pocket is carried by the continuous sidewall.

18. Apparatus according to claim 17, wherein the cover is attached to the continuous sidewall.

19. Apparatus according to claim 14, further comprising means for constrictively closing the cover about the animal enclosure in the deployed position of the cover.

20. Apparatus according to claim 19, wherein the means for constrictively closing the cover about the animal enclosure in the deployed position of the cover comprises a drawstring.
